(19) United States
(12) Patent Application Publication
(10) Pub. No.: US 2025/0361035 A1
(43) Pub. Date: Nov. 27, 2025

(54) MAGNETIC REACTION WHEEL OPERATING METHOD AND MAGNETIC REACTION WHEEL

(71) Applicant: NATIONAL TSING HUA UNIVERSITY, HSINCHU (TW)

(72) Inventors: Hong-Siang CHEN, HSINCHU (TW); Jen-Yuan CHANG, HSINCHU (TW); Kai-Yang PENG, HSINCHU (TW)

(21) Appl. No.: 18/818,937

(22) Filed: Aug. 29, 2024

(30) Foreign Application Priority Data
May 21, 2024 (TW) 113118767

(51) Int. Cl. B64G 1/28

(52) U.S. Cl. CPC B64G 1/283

(57) ABSTRACT

A magnetic reaction wheel operating method includes a sensing step, a judging step, and a switching step. In the sensing step, a plurality of object sensors of a magnetic reaction wheel sense at least one movable object. In the judging step, a processor determines whether a sensing signal strength value of a detecting one of the object sensors which is near a powered one of a plurality of coils satisfies a predefined condition. In the switching step, the processor turns off a current of the powered one of the coils, and then turns on a following one of the coils in a moving direction of the at least one movable object so as to allow the at least one movable object to move along the moving direction.

### RELATED APPLICATIONS

This application claims priority to Taiwan Application Serial Number 113118767, filed May 21, 2024, which is herein incorporated by reference.

### BACKGROUND

### Technical Field

The present disclosure relates to a reaction wheel operating method and a reaction wheel. More particularly, the present disclosure relates to a magnetic reaction wheel operating method and a magnetic reaction wheel.

### Description of Related Art

Due to the improvement of the technique, many spacecraft are developed. The attitude of the spacecraft needs to be controlled. The reaction wheel is one of the attitude control mechanisms. A conventional mechanical reaction wheel includes a motor, an axle, a bearing and a flywheel. An angular momentum can be generated by the flywheel driven by the motor. Through the principle of conservation of angular momentum, the attitude of the spacecraft can be changed. The purpose of changing the attitude of the spacecraft can be achieved.

However, the conventional mechanical reaction wheel is very expensive to manufacture and has very high requirements on tolerance and concentricity performance. Furthermore, when the conventional mechanical reaction wheel operates for a longer time, the axle and/or bearing will be worn, causing the axle and the bearing to become uneven and to vibrate. An operating stability of the conventional mechanical reaction wheel can be affected. The vibration not only affects the accuracy of attitude control easily, but also causes the conventional mechanical reaction wheel to fail to operate normally in severe cases.

In view of this, how to provide a reaction wheel without any axle and increase its operating efficiency has become the goal that those in the field pursue.

### SUMMARY

According to one aspect of the present disclosure, a magnetic reaction wheel operating method is provided. The magnetic reaction wheel operating method includes a sensing step, a judging step and a switching step. In the sensing step, a plurality of object sensors of a magnetic reaction wheel sense at least one movable object. The magnetic reaction wheel includes a tube body, the at least one movable object, a plurality of coils and the object sensors. The at least one movable object is disposed within the tube body. The coils are disposed at the tube body with intervals and are respectively configured to allow a plurality of currents selectively passing therethrough. Each of the coils of the magnetic reaction wheel includes a first side and a second side along a moving direction of the at least one movable object. Each of the object sensors is disposed at the second side of each of the coils. In the judging step, a processor determines whether a sensing signal strength value of a detecting one of the object sensors which is near a powered one of the coils satisfies a predefined condition. In the switching step, the processor turns off the current of the powered one of the coils when the sensing signal strength value of the detecting one of the object sensors satisfies the predefined condition, and then turns on a following one of the coils in the moving direction of the at least one movable object so as to allow the at least one movable object to move along the moving direction.

According to another aspect of the present disclosure, a magnetic reaction wheel, which is operated by the magnetic reaction wheel operating method, is provided. The magnetic reaction wheel includes the tube body, the at least one movable object, the coils and the object sensors. The at least one movable object is disposed within the tube body. The coils are disposed at the tube body with intervals, and each of the coils includes the first side and the second side along the moving direction the at least one movable object. Each of the object sensors is disposed at the second side of each of the coils.

### BRIEF DESCRIPTION OF THE DRAWINGS

The present disclosure can be more fully understood by reading the following detailed description of the embodiment, with reference made to the accompanying drawings as follows:

FIG. 1 is a three-dimensional schematic view of a magnetic reaction wheel according to a first embodiment of the present disclosure.

FIG. 2 is a partial schematic view of the magnetic reaction wheel according to the first embodiment of FIG. 1 at one moment.

FIG. 3 is a partial schematic view of the magnetic reaction wheel according to the first embodiment of FIG. 1 at another moment.

FIG. 4 is a three-dimensional schematic view of a magnetic reaction wheel according to a second embodiment of the present disclosure.

FIG. 5 is a partial side view of a magnetic reaction wheel according to a third embodiment of the present disclosure.

FIG. 6 is a partial side view of a magnetic reaction wheel according to a fourth embodiment of the present disclosure.

FIG. 7 is a block diagram of a magnetic reaction wheel operating method according to a fifth embodiment of the present disclosure.

### DETAILED DESCRIPTION

The embodiments of the present disclosure will be illustrated with drawings hereinafter. In order to clearly describe the content, many practical details will be mentioned with the description hereinafter. However, it will be understood by the reader that the practical details will not limit the present disclosure. In other words, in some embodiments of the present disclosure, the practical details are not necessary. Additionally, in order to simplify the drawings, some conventional structures and elements will be illustrated in the drawings in a simple way; the repeated elements may be labeled by the same or similar reference numerals.

In addition, the terms first, second, third, etc. are used herein to describe various elements or components, these elements or components should not be limited by these terms. Consequently, a first element or component discussed below could be termed a second element or component. Moreover, the combinations of the elements, the components, the mechanisms and the modules are not well-known, ordinary or conventional combinations, and whether the combinations can be easily completed by the one skilled in the art cannot be judged based on whether the elements, the components, the mechanisms or the module themselves are well-known, ordinary or conventional.

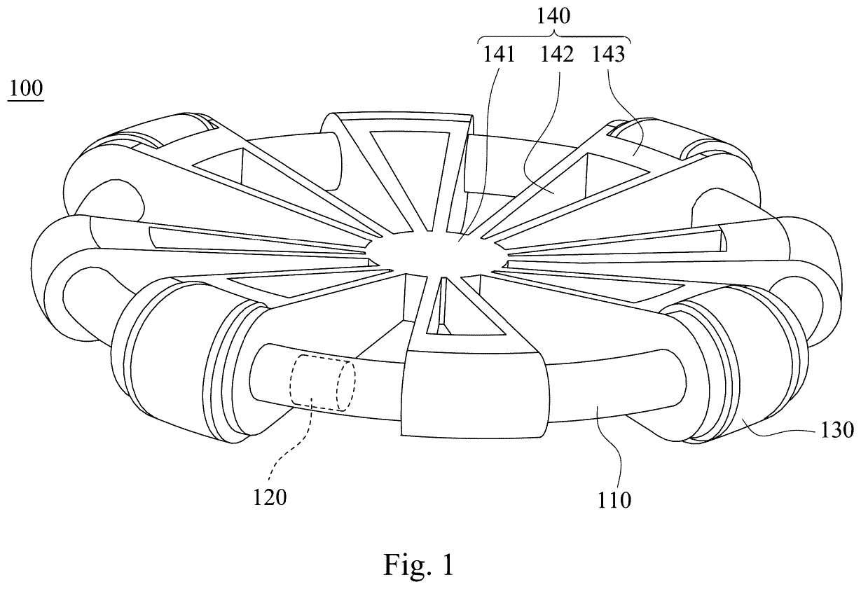

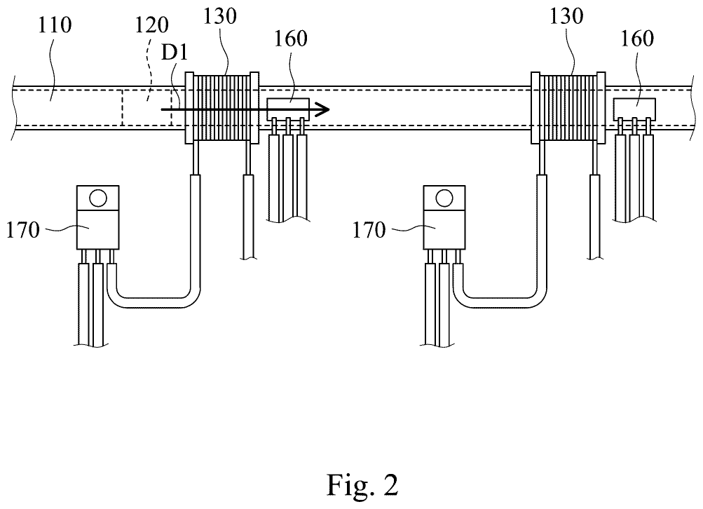

Please refer to FIG. 1. FIG. 1 is a three-dimensional schematic view of a magnetic reaction wheel 100 according to a first embodiment of the present disclosure. The magnetic reaction wheel 100 includes a tube body 110, at least one movable object 120, a plurality of coils 130 and a plurality of object sensors 160 (labelled in FIG. 2). The at least one movable object 120 is disposed within the tube body 110. The coils 130 are disposed at the tube body 110 with intervals. Each of the coils 130 includes a first side and a second side along a moving direction D1 (labelled in FIG. 2) of the at least one movable object 120. Each of the object sensors 160 is disposed at the second side of each of the coils. The coils 130 are respectively configured to allow a plurality of currents selectively passing therethrough. The currents are turned on and off in sequence so as to allow the at least one movable object 120 to move along the moving direction D1 of the at least one movable object 120 in the tube body 110. In the first embodiment, a number of the at least one movable object 120 is one. A number of the coils 130 and a number of the object sensors 160 are both four, but the present disclosure is not limited thereto.

Therefore, by turning on and off specific coils 130 according to the sensing of the object sensors 160, the movable object 120 can be driven effectively to circle in the tube body 110 so as to generate an angular momentum to control the attitude of a spacecraft. Therefore, the reaction wheel without any axle can be effectively driven.

In the first embodiment, the tube body 110 can be in a ring tubular shape and can be wound into a circle. In other embodiments, the tube body can be wound into other shapes, such as an oval, a triangle, etc., but the present disclosure is not limited thereto.

The coils 130 can generate a magnetic field by turning on the currents according to the electromagnetic induction to attract the movable object 120 to move forward. To be more specific, the coils 130 can be made of copper for a better conductivity and for decreasing the energy dissipation through the heat dissipation at the same time. In other embodiments, the coils can be made of other conductive substances, but the present disclosure is not limited thereto.

Each of the coils 130 can be wound at an outer surface of the tube body 110. The coils 130 can generate the magnetic field through the electromagnetic induction, and the maximum value of the magnetic field is located at the center of the coils 130. Therefore, the magnetic reaction wheel 100 can further include a frame 140. The frame 140 is used to support the tube body 110 and is configured for the coils 130 to be disposed thereon. To be more specific, the frame 140 can include a center section 141, a plurality of connecting arms 142 and a plurality of winding sections 143. Each of the connecting arms 142 is in a radial shape and is integrally connected to the center section 141. Each of the winding sections 143 is integrally connected to a distal end of each of the connecting arms 142. Consequently, the frame 140 is configured as a disc-shaped structure. Each of the winding sections 143 is configured to be wound by the coils 130, and each of the winding sections 143 includes a center hole for the tube body 110 passing therethrough. Therefore, each of the coils 130 can be wound at each of the winding sections 143 so as to generate the maximum magnetic field at the center of the tube body 110 to drive the movable object 120 forward. In other embodiments, the coils can be placed at any position according to the requirements, but the present disclosure is not limited thereto.

In the first embodiment, the movable object 120 can be made of a magnetic permeability substance or a magnetic substance. The magnetic permeability substance is a substance that can be attracted or pushed by magnetic fields. The magnetic substance is a substance that has its own magnetic field while the magnetic substance can be attracted or pushed by magnetic fields. Both of the magnetic permeability substance and the magnetic substance can be driven to move in the moving direction D1 of the movable object 120 by the magnetic field generated by the current of each of the coils 130. In the first embodiment, the movable object 120 is made of neodymium substance. In other embodiments, other magnetic substances or magnetic permeability substances such as steel can be utilized, but the present disclosure is not limited thereto.

Furthermore, the magnetic reaction wheel 100 can further include an oil located at an inner wall of the tube body 110. The oil can be a mineral oil for example. By adding the oil to the inner wall of the tube body 110, the friction coefficient of the inner wall can be reduced. The movable object 120 is not easy to rub against the inner wall of the tube body 110, thereby preventing the inner wall or the movable object 120 from being damaged. The smoothness of the movable object 120 moving within the tube body 110 can also be improved and the movable object 120 can be more adaptive to different surfaces. In other embodiments, the oil can be any liquid with lubricating effect, but the present disclosure is not limited thereto.

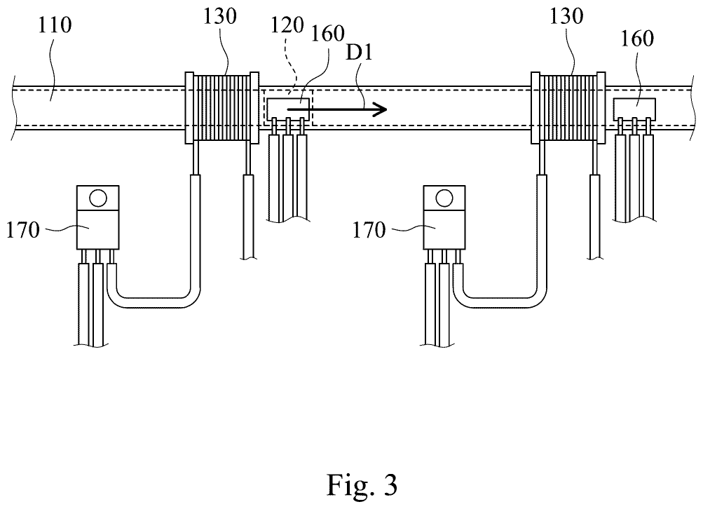

Please refer to FIG. 2 and FIG. 3. FIG. 2 is a partial schematic view of the magnetic reaction wheel 100 according to the first embodiment of FIG. 1 at one moment. FIG. 3 is a partial schematic view of the magnetic reaction wheel 100 according to the first embodiment of FIG. 1 at another moment. Please note that in FIG. 2 and FIG. 3, a small section of the tube body 110 is extracted and presented in a straight line to facilitate explanation, but the present disclosure is not limited thereto.

The magnetic reaction wheel 100 can further include a plurality of current control elements 170. Each of the current control elements 170 is electrically connected to each of the coils 130 and is configured to turn on and off each of the currents. In the first embodiment, a number of the current control elements 170 is four, but the present disclosure is not limited thereto. Each of the current control elements 170 can be a metal oxide semiconductor field effect transistor (MOSFET) and is electrically connected to one end of each of the coils 130. Since the MOSFET can be switched fast, the MOSFET is suitable as a switch to turn on and off the current of each of the coils 130. In other embodiments, the current control elements can be any object with switching function, but the present disclosure is not limited thereto. A processor can be electrically connected to each of the current control elements 170 and whether the current can pass through each of the coils 130 can be controlled through each of the current control elements 170. That is to say, the processor can sequentially control the current control elements 170 corresponding to each of the coils 130 so as to allow each of the coils 130 to generate the magnetic field at different positions in the tube body 110 to drive the movable object 120 to move continuously. The processor can be a central processing unit (CPU), a digital signal processor (DSP), a micro processing unit (MPU), a micro controller unit (MCU), etc., which can be programmed to achieve specific functions. In the first embodiment, the processor can be an Arduino development board, but the present disclosure is not limited thereto.

Each of the object sensors 160 is disposed at the second side of each of the coils 130 so as to sense a position of the movable object 120. That is to say, when the movable object 120 moves, the movable object 120 will first pass through the first side of each of the coils 130 and then pass through the second side of each of the coils 130. Each of the object sensors 160 can be a hall sensor for detecting a magnetic field strength and converting the magnetic field strength into a sensing signal strength value such as a voltage value. When the movable object 120 is close to the object sensors 160, the current position and moving direction D1 of the movable object 120 can be calculated according to the sensing signal strength value output by the object sensors 160. In other embodiments, each of the object sensors can be any sensor that can detect a position, such as an optical sensor, etc., but the present disclosure is not limited thereto.

A predefined condition can be saved in the processor in advance. For example, when the sensing signal strength value generated by the object sensors 160 is larger than or equal to a threshold, the processor can determine the movable object 120 corresponding to the object sensors 160 and can determine the position of the movable object 120. Accordingly, the currently powered coil 130 is turned off, and the next coil 130 is turned on. Therefore, the movable object 120 can be continuously moved along the moving direction D1 of the movable object 120 and the operation efficiency is improved.

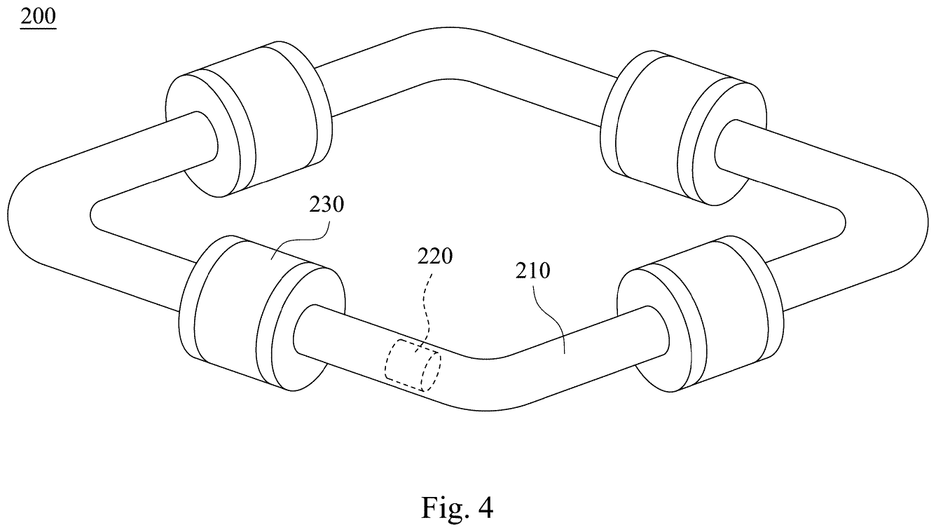

Please refer to FIG. 4. FIG. 4 is a three-dimensional schematic view of a magnetic reaction wheel 200 according to a second embodiment of the present disclosure. The magnetic reaction wheel 200 of the second embodiment is similar to the magnetic reaction wheel 100 of the first embodiment. The magnetic reaction wheel 200 includes a tube body 210, a movable object 220 and four coils 230. The difference is that the tube body 210 can be a quadrilateral structure. The remaining details are similar to those of the first embodiment and will not be described again.

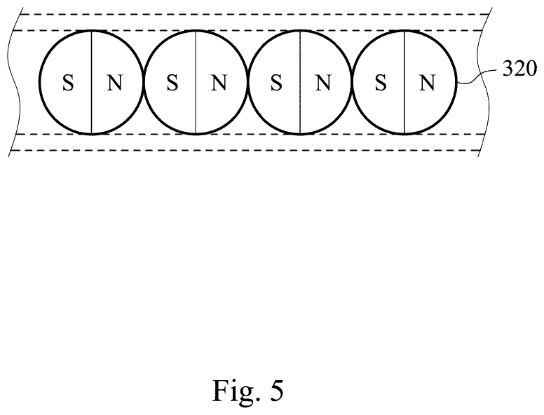

Please refer to FIG. 5. FIG. 5 is a partial side view of a magnetic reaction wheel according to a third embodiment of the present disclosure. The magnetic reaction wheel of the third embodiment is similar to the magnetic reaction wheel 100 of the first embodiment. The magnetic reaction wheel includes a movable object 320, a tube body (not labelled) and a plurality of coils (not shown). The difference is that a number of the movable object 320 can be plural and be attached in series. The movable objects 320 are attached to each other by attraction and form a series structure so as to increase the moment of inertia of the movable objects 320 moving around the tube body and provide greater angular momentum to control the magnet reaction wheel. To be more specific, the number of the movable objects 320 can be four, and each of movable objects 320 can be magnetic substance such as a magnet. Each of the movable objects 320 is in a spherical shape and includes an N pole and an S pole. The movable objects 320 attract each other through the N poles and the S poles. In other embodiments, the number of the movable objects can be configured according to the requirements. Some of the movable objects are magnetic to allow all the movable objects being connected magnetically, but the present disclosure is not limited thereto.

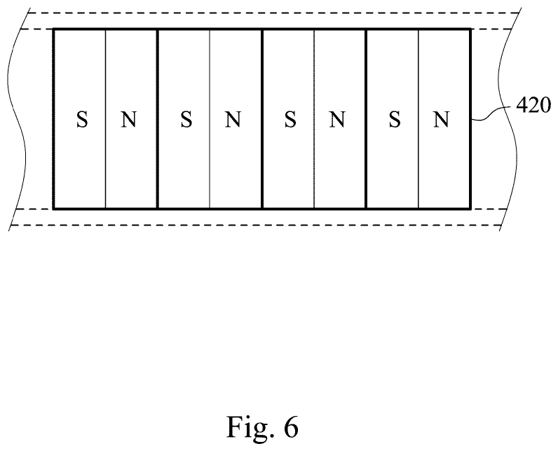

Please refer to FIG. 6. FIG. 6 is a partial side view of a magnetic reaction wheel according to a fourth embodiment of the present disclosure. The magnetic reaction wheel of the fourth embodiment is similar to the magnetic reaction wheel 100 of the first embodiment. The magnetic reaction wheel includes a movable object 420, a tube body (not labelled) and a plurality of coils (not shown). The difference is that a number of the movable object 420 can be plural. As shown in FIG. 6, the number of movable objects 420 is four, and each of the movable objects 420 is in a cylindrical shape. Each of the movable objects 420 is magnetic substance and includes an N pole and an S pole. The remaining details will not be described again.

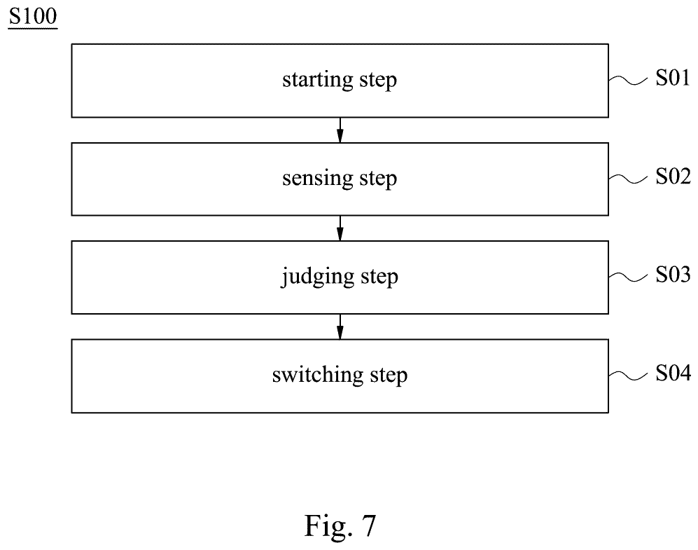

Please refer to FIG. 7. FIG. 7 is a block diagram of a magnetic reaction wheel operating method S100 according to a fifth embodiment of the present disclosure. The magnetic reaction wheel operating method S100 includes a sensing step S02, a judging step S03 and a switching step S04. The details of the magnetic reaction wheel operating method S100 will be explained below with reference to the magnetic reaction wheel 100 in FIG. 1 to FIG. 3.

In the sensing step S02, the object sensors 160 of a magnetic reaction wheel 100 sense the movable object 120. The magnetic reaction wheel 100 includes the tube body 110, the movable object 120, the coils 130 and the object sensors 160. The movable object 120 is disposed within the tube body 110. The coils 130 are disposed at the tube body 110 with intervals and are respectively configured to allow the currents selectively passing therethrough. Each of the coils 130 of the magnetic reaction wheel 100 includes the first side and the second side along the moving direction D1 of the movable object 120. Each of the object sensors 160 is disposed at the second side of each of the coils 130. In the judging step S03, the processor determines whether the sensing signal strength value of the detecting one of the object sensors 160 which is near a powered one of the coils 130 satisfies the predefined condition. In the switching step S04, the processor turns off the current of the powered one of the coils 130 when the sensing signal strength value of the detecting one of the object sensors 160 satisfies the predefined condition, and then turns on a following one of the coils 130 in the moving direction D1 of the movable object 120 of the movable object 120 so as to allow the movable object 120 to move along the moving direction D1 of the movable object 120.

That is to say, as shown in FIG. 2 and FIG. 3, the left side of each of the coils 130 is the first side, and the right side of each of the coils 130 is the second side. When the coils 130 are powered on, the coils 130 will generate the magnetic fields according to electromagnetic induction. A direction of the magnetic field is parallel to an extension direction of the tube body 110. Therefore, the magnetic field can give the movable object 120 an attraction force to drive the movable object 120 to move from the first side to the second side. When each of the object sensors 160 is disposed at the second side of each of the coils 130, the position of the movable object 120 can be sensed by, for example, sensing the strength of the magnetic field to control the switching of the coils 130.

When driving the movable object 120, the movable object 120 is driven to move continuously by turning on the coils 130 in sequence. Therefore, the current only passes through one coil 130 at a time. This coil 130 with the current passing therethrough can be defined as the powered one, and the object sensor 160 located at the second side of the powered one of the coils 130 can be defined as the detecting one, and the next coil 130 located at the moving direction D1 of the movable object 120 of the powered one of the coils 130 can be defined as the following one. In the judging step S03, the processor can determine whether the movable object 120 has passed the powered one of coils 130 by receiving the sensing signal strength value from the detecting one of the object sensors 160. If the predefined conditions are satisfied, the switching step S04 is executed. The powered one of the coils 130 will be turned off, and the following one of the coils 130 will be turned on, thereby driving the movable object 120 to move continuously. Therefore, the powered one of the coils 130 will generate a magnetic field in the opposite direction to the original magnetic field according to Lenz's law, and thus the movable object 120 is pushed to move forward along the moving direction D1 of the movable object 120. The following one of the coils 130 continues to attract the movable object 120 to move forward along the moving direction D1 of the movable object 120 due to the electromagnetic induction. After that, the following one of the coils 130 becomes a new powered one, and the coil 130 followed by the new powered one of the coils 130 along the moving direction D1 of the movable object 120 of the movable object 120 is a new following one of the coils 130. Then the sensing step S02, the judging step S03 and the switching step S04 are restarted in sequence. Therefore, the coils 130 can be turned on in sequence continuously and then drive the movable object 120.

Furthermore, the magnetic reaction wheel operating method S100 can further include a starting step S01. The starting step S01 simultaneously turns on the currents of the coils 130. Since the position of the movable object 120 is unknown in the beginning, the currents of the coils 130 can be turned on simultaneously to generate the magnetic field so as to attract the movable object 120. Then each of the object sensors 160 can be configured to detect the position of the movable object 120.

In the starting step S01, if the object sensors 160 do not detect the movable object 120 within a predefined time, the current of each of the coils 130 will be turned off. When the current of each of the coils 130 is turned on, the heat will be generated at the same time. In order to prevent the coils 130 from overheating and causing equipment damage, a mechanism is set up to turn off the currents. In the fifth embodiment, the predefined time is 50 seconds to 70 seconds. In other embodiments, different predefined times can be set according to different circuit characteristics, but the present disclosure is not limited thereto.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A magnetic reaction wheel operating method, comprising:
a sensing step, wherein a plurality of object sensors of a magnetic reaction wheel sense at least one movable object, the magnetic reaction wheel comprises a tube body, the at least one movable object, a plurality of coils and the object sensors, the at least one movable object is disposed within the tube body, the coils are disposed at the tube body with intervals and are respectively configured to allow a plurality of currents selectively passing therethrough, each of the coils of the magnetic reaction wheel comprises a first side and a second side along a moving direction of the at least one movable object, and each of the object sensors is disposed at the second side of each of the coils;
a judging step, wherein a processor determines whether a sensing signal strength value of a detecting one of the object sensors which is near a powered one of the coils satisfies a predefined condition; and
a switching step, wherein the processor turns off the current of the powered one of the coils when the sensing signal strength value of the detecting one of the object sensors satisfies the predefined condition, and then turns on a following one of the coils in the moving direction of the at least one movable object so as to allow the at least one movable object to move along the moving direction.

2. The magnetic reaction wheel operating method of claim 1, wherein the magnetic reaction wheel further comprises an oil, and the oil is located at an inner wall of the tube body.

3. The magnetic reaction wheel operating method of claim 1, wherein the magnetic reaction wheel further comprises a plurality of current control elements, each of the current control elements is electrically connected to each of the coils, and in the switching step, the processor controls each of the current control elements so as to turn off the current of each of the coils.

4. The magnetic reaction wheel operating method of claim 1, further comprising:
a starting step, wherein the currents of the coils are turned on simultaneously.

5. The magnetic reaction wheel operating method of claim 4, wherein in the starting step, the current of each of the coils is turned off if the object sensors do not sense the at least one movable object within a predefined time.

6. A magnetic reaction wheel, which is operated by the magnetic reaction wheel operating method of claim 1, the magnetic reaction wheel comprising:
the tube body;
the at least one movable object disposed within the tube body;
the coils disposed at the tube body with intervals, each of the coils comprising the first side and the second side along the moving direction of the at least one movable object; and
the object sensors, each of the object sensors disposed at the second side of each of the coils.

7. The magnetic reaction wheel of claim 6, wherein the at least one movable object is in a cylindrical shape or a spherical shape.

8. The magnetic reaction wheel of claim 6, wherein the at least one movable object is a magnetic permeability substance.

9. The magnetic reaction wheel of claim 6, wherein the at least one movable object is a magnetic substance.

10. The magnetic reaction wheel of claim 9, wherein a number of the at least one movable object is plural, and the at least one movable object is magnetically attached to each other so as to form a series structure.

11. The magnetic reaction wheel of claim 6, wherein the tube body is in a ring tubular shape.

12. The magnetic reaction wheel of claim 6, further comprising an oil located at an inner wall of the tube body.

13. The magnetic reaction wheel of claim 6, further comprising a plurality of current control elements, each of the current control elements being electrically connected to each of the coils.

14. The magnetic reaction wheel of claim 6, wherein each of the coils is wound at an outer surface of the tube body.
